(19) United States
(12) Patent Application Publication
(10) Pub. No.: US 2021/0316748 A1
(43) Pub. Date: Oct. 14, 2021

(54) METHOD FOR PROVIDING DRIVING ASSISTANCE AND VEHICLE USING THE METHOD

(71) Applicant: Chiun Mai Communication Systems, Inc., New Taipei (TW)

(72) Inventors: CHIH-PU HSU, New Taipei (TW); YI-CHIN WANG, New Taipei (TW); HSIU-HUA YEN, New Taipei (TW); JIAN-CHENG LIN, New Taipei (TW)

(21) Appl. No.: 17/226,403

(22) Filed: Apr. 9, 2021

(30) Foreign Application Priority Data
Apr. 10, 2020 (CN) 202010280642.7

(51) Int. Cl. B60W 50/14; B60W 40/04; B60W 40/10; G06F 16/338; G06F 16/332; B60W 50/00

(52) U.S. Cl. CPC B60W 50/14; B60W 40/04; B60W 40/10; B60W 2556/45; G06F 16/332; B60W 50/0098; G06F 16/338

(57) ABSTRACT

A driving assistance method for operating a vehicle includes establishing a database, wherein the database includes pre-stores keywords, the keywords are defined as words related to traffic; obtaining electronic texts of traffic rules; extracting keywords in the electronic texts according to the database; generating a trigger condition based on the extracted keywords; obtaining a plurality of current driving parameters of the vehicle; and sending a driving assistance command when the current driving parameters satisfy the trigger condition. The invention also provides a vehicle using the driving assistance method.

### CROSS-REFERENCE TO RELATED DISCLOSURES

This disclosure claims priority to Chinese Patent Application No. CN202010280642.7 filed on Apr. 10, 2020, the contents of which are incorporated by reference herein.

### FIELD

The disclosure generally relates to driving safety, and particular to a method for providing driving assistance and a vehicle using the method based on traffic rules.

### BACKGROUND

Road traffic is getting heavier. A driver who is unfamiliar with local traffic rules, such as a new driver or when the driver is driving in an unfamiliar country or region, can be driving illegally, resulting in fines, deductions, and even traffic accidents.

### BRIEF DESCRIPTION OF THE DRAWINGS

Implementations of the present technology will now be described, by way of example only, with reference to the attached figures, wherein:

FIG. 1 is a block diagram of a vehicle, according to an embodiment.

FIG. 2 is a block diagram of a system for providing driving assistance, according to an embodiment.

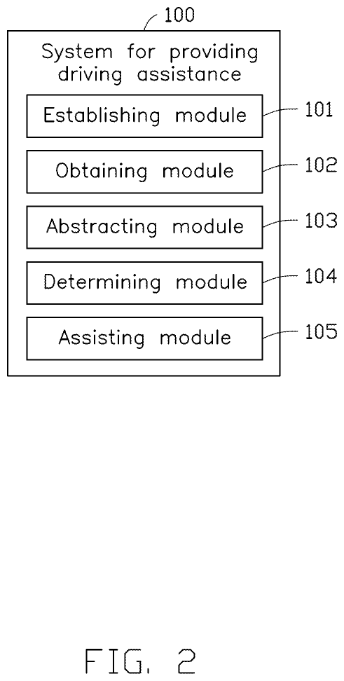

FIG. 3 is a flowchart of a driving assistance method for operating a vehicle using the system of FIG. 2, according to an embodiment.

FIG. 4 is a schematic view of electronic texts of traffic rules used in the method.

FIG. 5 is a schematic view of keywords extracted from the electronic texts in the method.

FIG. 6 is a schematic diagram of a trigger condition generated in the method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

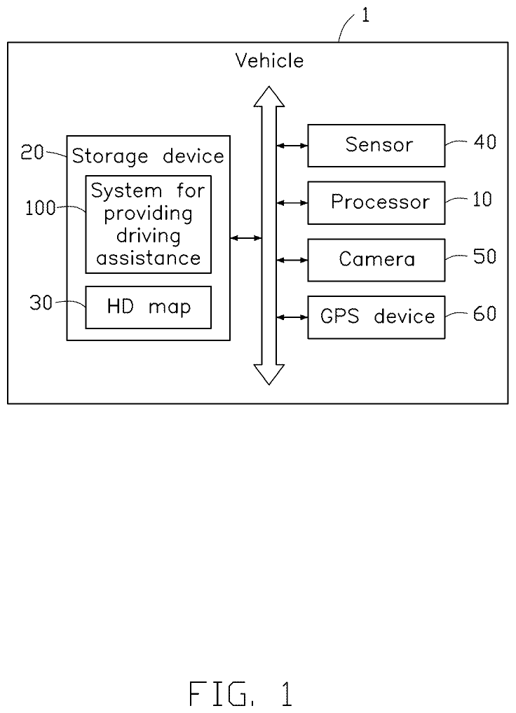

FIG. 1 is a block diagram of a vehicle 1 including a system for providing driving assistance 100, according to an embodiment. The vehicle 1 includes a sensor 40, a camera 50, and a GPS device 60.

The sensor 40 is configured to sense a plurality of current driving parameters of the vehicle 1. The current driving parameters include a vehicle-related parameter and a traffic-related parameter. In an embodiment, the vehicle-related parameter includes a combination of at least one or more of a speed, an acceleration, a relative position, a yaw angle, an indicator status, a driving direction, a driving distance, an accelerator pedal signal, a braking signal, and a steering signal. In this embodiment, the sensor 40 can be a combination of at least one or more of a lidar, a speed sensor, an acceleration sensor, a yaw angle sensor, and an indicator light sensor. In this embodiment, the acceleration sensor can sense changes of a linear velocity and an angular velocity.

In this embodiment, the number of the sensors 40 can be more than one, and the more than one sensors 40 are positioned at four wheels, a head portion, and a rear portion of the vehicle 1.

In another embodiment, the sensor 40 can include eight cameras, twelve ultrasound radars, and one millimeter wave radar.

In other embodiment, the sensor 40 can be, but is not limited to, the above-mentioned sensors, and can also include a combination of one or more of a millimeter wave radar, an ultrasonic radar, a lidar, an infrared radar, a wheel speed sensor, a thermal imaging sensor, an accelerator, and a gyroscope.

In other embodiment, the vehicle-related parameter can be obtained through the sensor 40 and can be also obtained by other ways except the sensor 40, for example, through a driving control computer (not shown) to obtain the vehicle speed, the accelerator pedal signal, the braking signal, and the driving information such as a turning signal and a direction light signal.

In another embodiment, the camera 50 can be positioned outside the vehicle 1. The camera 50 can obtain images outside the vehicle 1. The traffic-related parameter and the vehicle-related parameter can be obtained from the image through an image recognition technology. Precise positioning information of the vehicle 1 can be also obtained from the image combining with the GPS device 60.

The traffic-related parameter includes one or more of a road-related parameter, a pedestrian-related parameter, a signal light-related parameter, a traffic sign-related parameter, an environment-related parameter, and a distance between the vehicle 1 and another front, back, left, or right vehicle. The road-related parameter includes the number of lanes, a lane type, a lane line marking, a lane speed limit value, a one-way driving requirement, a lane prohibition of overtaking, an allocation of intersection lanes, etc. In other embodiment, the traffic-related parameters can also include other traffic-related parameter such as a temporary traffic control.

In another embodiment, the camera 50 can be positioned inside the vehicle 1. The camera 50 can obtain a plurality of images inside the vehicle 1. A driver-related parameter and a passenger-related parameter can be obtained from the image through the image recognition technology. The driver-related parameter includes a driving time, a head parameter, a hand parameter, and a foot parameter. The head parameter includes a blinking frequency, a mouth opening frequency, etc. The passenger-related parameter includes the number of passengers in the vehicle 1. The driver-related parameter and the passenger-related parameter can be used to determine whether the driving of the vehicle 1 does not comply with the traffic rules, such as fatigue driving or overloading.

In another embodiment, the camera 50 can be positioned outside the vehicle 1 to obtain a plurality of images outside the vehicle 1. At least one of the road-related parameter, the pedestrian-related parameter, the signal light-related parameter, the traffic sign-related parameter, the environment-related parameter, and the distance between the vehicle 1 and another front, back, left, or right vehicle of the traffic-related parameter can be obtained from the images through the image recognition technology. For example, the camera 50 can analyze the images outside the vehicle 1 obtained by the camera 50 through the image recognition technology to determine the number of the lanes, the lane type, the lane line marking, the lane speed limit value, the one-way driving requirement, the lane prohibition of overtaking, the allocation of intersection lanes, etc. The camera 50 can analyze the images outside the vehicle 1 obtained by the camera 50 through image recognition technology to determine whether a pedestrian passes in front of the vehicle 1 or a pedestrian passes through the lane, and can also determine the signal-related parameter of the intersection, for example, the color of the signal lights.

The GPS device 60 is configured to locate the vehicle 1, and combined with the vehicle 1's built-in map database, the current position of the vehicle 1 can be determined. The GPS device 60 is a high-precision (HP) GPS device, and the detection accuracy can reach the detection side Describe the lane where the vehicle 1 is located. The vehicle 1 further includes a High Definition (HD) map 30. The HD map 30 is configured to obtain the lane parameter, the signal parameter, and the traffic sign parameter of the traffic-related parameter in the HD map 30. Thus, the lane where the vehicle 1 is located can be accurately by combining the HD map 30 with the GPS device 60 and the camera 50.

The vehicle 1 further includes at least one storage device 20 providing one or more memory functions, and at least one processor 10. In at least one embodiment, the for providing driving assistance system 100 may include computerized instructions in the form of one or more programs, which are stored in the storage device 20 and executed by the at least one processor 10 to perform operations of the vehicle 1.

The storage device 20 stores one or more programs, such as programs of the operating system, other applications of the vehicle 1, and the HD map 30. In some embodiments, the storage device 20 may include a memory of the vehicle 1 and/or an external storage card, such as a memory stick, a smart media card, a compact flash card, or any other type of memory card. FIG. 1 illustrates only one example of the vehicle 1, other examples may include more or fewer components than as illustrated, or have a different configuration of the various components.

In at least one embodiment, the system for providing driving assistance 100 may include one or more modules, for example, an establishing module 101, an obtaining module 102, an abstracting module 103, a determining module 104, and an assisting module 105. In general, the word “module”, as used herein, refers to logic embodied in hardware or firmware, or to a collection of software instructions, written in a programming language, such as Java, C, or assembly. One or more software instructions in the modules may be embedded in firmware, such as in an EPROM. The modules described herein may be implemented as either software and/or hardware modules and may be stored in any type of non-transitory computer-readable medium or other storage devices. Some non-limiting examples of a non-transitory computer-readable medium include CDs, DVDs, BLU-RAY, flash memory, and hard disk drives.

The establishing module 101 can be configured to establish a database, the database pre-stores a plurality of keywords, and the keywords are defined as words related to traffic. The obtaining module 102 can be configured to obtain electronic texts of traffic rules which can include traffic rules and/or traffic laws. The obtaining module 102 can be also configured to obtain the current driving parameters of the vehicle 1 through the sensor 40, the camera 50, the HD map 30, and the GPS device 60.

The abstracting module 103 can be configured to extract keywords in the electronic texts according to the database.

The determining module 104 can be configured to generate a trigger condition according to the extracted keywords. The determining module 104 can be also configured to determine whether the current driving parameters satisfy the trigger condition.

The assisting module 105 can be configured to send a driving assistance command to the vehicle 1 when the current driving parameters satisfy the trigger condition.

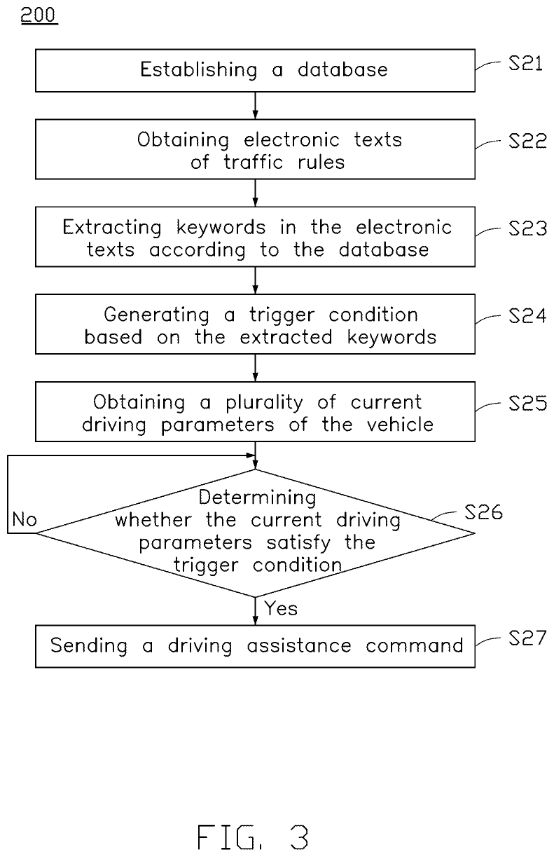

FIG. 3 is a flowchart of a driving assistance method for operating a vehicle 200, according to an embodiment of the present application. The example method 200 is provided by way of example, as there are a variety of ways to carry out the method 200. The method 200 described below can be carried out using the configurations illustrated in FIG. 1, for example, and various elements of these figures are referenced in explaining exemplary method 200. Each block shown in FIG. 3 represents one or more processes, methods, or subroutines, carried out in the exemplary method 200. Furthermore, the illustrated order of blocks is by example only and the order of the blocks can change according to the present disclosure. Additional blocks may be added or fewer blocks may be utilized, without departing from this disclosure. The exemplary method 200 can begin at block S21.

At block S21, the establishing module 101 establishes a database. The database pre-stores a plurality of keywords. The keywords are defined as words related to traffic.

The database can be established based on traffic rules of multiple countries or regions. Thus, the database can include a plurality of keywords in different languages, for example, English, simplified Chinese characters, traditional Chinese characters, etc. In an embodiment, the database may automatically download or automatically switch the keywords in different languages according to the position information of the vehicle 1 obtained by the GPS device 60.

The keywords include traffic-related noun words, driving-related verb words, or a combination of the traffic-related noun words and the driving-related verb words. The traffic-related noun words include a plurality of road-related words and a plurality of vehicle-related words. The road-related words include intersection, lane, pedestrian, parking region, sidewalk, etc. The vehicle-related words include truck, car, taxis, etc. The driving-related verb words include acceleration, deceleration, turning left, turning right, changing lane, overloading, drunk driving, fatigue driving, etc.

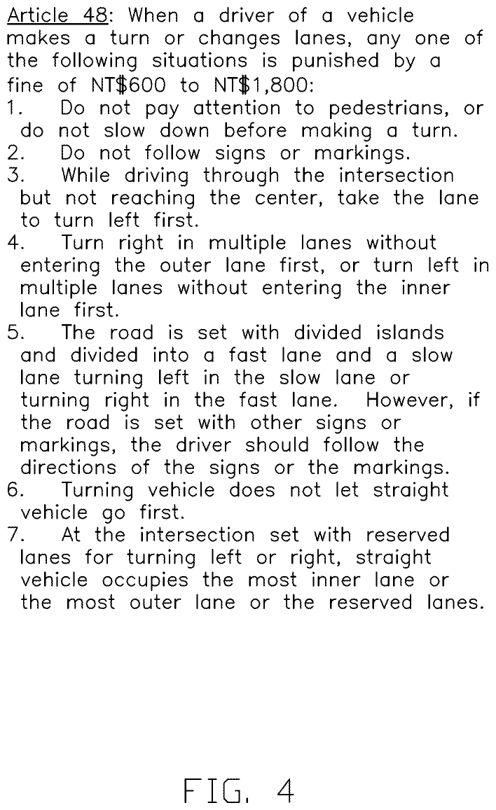

At block S22, the obtaining module 102 obtains electronic texts of traffic rules. FIG. 4 shows the electronic texts of some of the traffic rules. The electronic texts of the traffic rules can be prestored in the storage device 20. When the vehicle 1 is started, the obtaining module 102 reads the electronic texts from the storage device 20. In other embodiment, the electronic texts can also be obtained by the obtaining module 102 from paper documents of the traffic rules through OCR technology. In an embodiment, the obtaining module 102 can automatically download from the network or switch the electronic texts of the traffic rules in the corresponding language according to the position information of the vehicle 1 obtained by the GPS device 60.

At block S23, the abstracting module 103 extracts keywords in the electronic texts according to the database.

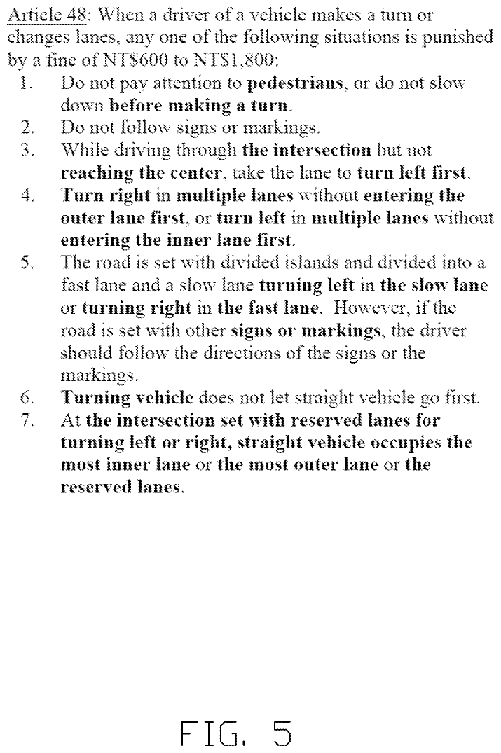

In an embodiment, the abstracting module 103 compares the electronic texts with pre-stored keywords. When the electronic text exists words which are consistent with the pre-stored keywords, the abstracting module 103 stores the words. For example, referring to FIG. 5, a first sentence of the electronic texts is “Do not pay attention to the pedestrians, or do not slow down before making a turn”. The extracted keywords could include the traffic-related nouns “pedestrian” and the driving-related verb word “turn”. The third sentence of the electronic texts is “While driving through the intersection but not reaching the center, take the lane to turn left first”. The extracted keywords could include the combination of the driving-related verb words “driving through” and “reach”, and the traffic-related noun words “intersection” and “center” which includes “driving through the intersection” and “reaching the center”, and the driving-related verb word “turn left”.

In other embodiment, when the words in the electronic texts are inconsistent with the pre-stored keywords, the words are deleted. In other embodiment, the words in the electronic texts which are inconsistent with the pre-stored keywords can be semantically analyzed to find the close keyword or no action is taken.

At block S24, the determining module 104 generates a trigger condition according to the extracted keywords.

In an embodiment, the trigger condition includes a preset driving scenario and a preset driving operation, where the preset driving scenario is established according to the extracted keywords, and the preset driving operation complies with the traffic rules.

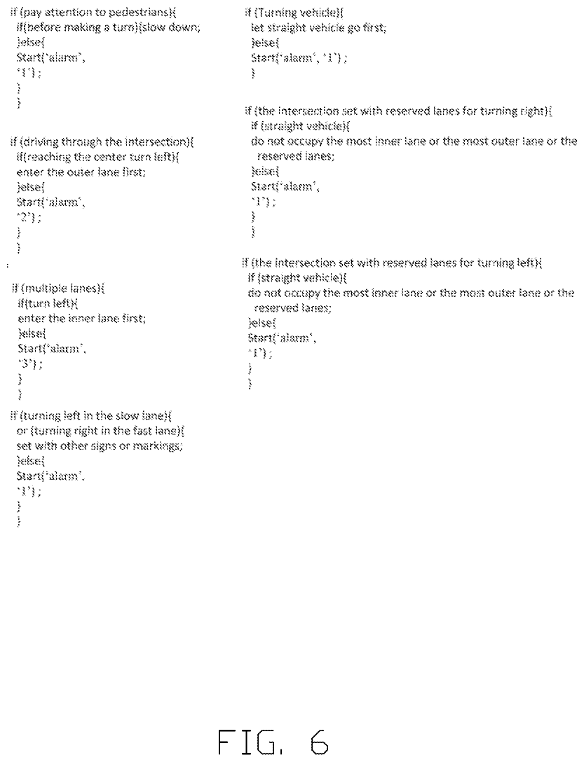

In an embodiment, the determining module 104 generates the trigger condition according to the keywords contained in the electronic texts by taking each sentence as a unit, and each sentence corresponds to one trigger condition. In an embodiment, for example, referring to FIG. 6, the keywords extracted from a first sentence of the electronic texts include “pedestrians” and “turn”, and the first trigger condition includes a first preset driving scenario that is there is a pedestrian within a preset range of the vehicle 1 or the vehicle 1 is before making a turn and a corresponding first preset driving operation that is decelerating and slowing down. The keywords extracted from a second sentence of the electronic texts includes “driving through the intersection”, “reaching the center”, and “turn left”, and the second trigger condition includes a second preset driving scenario that is the vehicle 1 is driving through the intersection or the vehicle 1 reaches the center, and turns left and a corresponding second preset driving operation is firstly entering the outer lane.

In another embodiment, the sentence can also be a text that does not start with a digital serial number or end with a period, for example, the beginning and end of the sentence can be determined according to a preset text length, for example, 20 characters.

At block S25, the obtaining module 102 obtains current driving parameters of the vehicle 1 through the HD map 30, the sensor 40, the camera 50, and the GPS device 60.

The current driving parameters include at least one of a vehicle-related parameter, a driver-related parameter, a passenger-related parameter, and a traffic-related parameter. The vehicle-related parameter includes at least one of a vehicle speed, a relative position, a shape, a yaw angle, an indicator light status, a driving direction, a driving mileage, a pedal signal, a braking signal, and a steering signal configured to indicate the driving state of the vehicle 1. The driver-related parameter includes at least one of a driving time, a head parameter, a hand parameter, and a foot parameter configured to indicate a driving state of the driver, for example, whether the driver is fatigued. The passenger-related parameter includes passenger information and behaviors of the passenger configured to indicate a passenger status, for example, whether the vehicle is overloaded, whether the passenger is wearing seat belts, etc. The traffic-related parameter includes at least one of a road-related parameter, a pedestrian-related parameter, a signal-related parameter, a traffic sign-related parameter, an environment-related parameter, and a distances between the vehicle 1 and another front, back, left, and right other vehicle and configured to indicate whether the driving of the vehicle 1 complies with road directions, signal lights, etc.

At block S26, the determining module 104 determines whether the current driving parameters satisfy the trigger condition.

When the vehicle 1 is driving in the preset driving scenario and the driving of the vehicle 1 does not comply with the preset driving operation, the determining module 104 determines that the trigger condition is triggered. When the vehicle 1 is in the preset driving scenario and the driving of the vehicle 1 complies with the preset driving operation, the determining module 104 determines that the trigger condition is not satisfied.

In a first embodiment, the sensor 40 of the vehicle 1 senses that there is a pedestrian with in a preset range of the vehicle 1, or the vehicle 1 is preparing to turn, for example, the turning light of the vehicle 1 has been turned on, and the driver's hand parameter indicates that the vehicle 1 is preparing to turn, or front wheels of the vehicle 1 have begun to deflect, that is, the vehicle 1 enters into the first preset driving scenario. If the sensor 40 senses that the vehicle 1 is slowing down, that means the driving of the vehicle 1 complies with the first preset driving operation, the determining module 104 determines that the trigger condition is not satisfied, and no action is taken. If the sensor 40 senses that the vehicle 1 is not slowing down, that means the driving of the vehicle 1 does not comply with the preset driving operation, the determining module 104 determines that the trigger condition is triggered, the process goes to block S27.

In a second embodiment, the determining module 104 can determine that the vehicle 1 is driving through the intersection, reaching the center, preparing to turn left (i.e. the vehicle 1 is driving in the second preset driving scenario) according to the sensing data sensed by the sensor 40 and the position information located by the GPS device 60 and the HD map 30. If the sensor 40 further senses that the vehicle 1 has entered the outer lane, the driving of the vehicle 1 complies with the second preset driving operation and the traffic rules, no action is taken.

In another embodiment, the determining module 104 can determine that the vehicle 1 is driving through the intersection, reaching the center, preparing to turn left (i.e. the vehicle 1 is driving in the second preset driving scenario) according to the sensing data sensed by the sensor 40 and the position information located by the GPS device 60. If the camera 50 further sense that the vehicle 1 has entered the outer lane by analyzing the images obtained by the camera 50, the driving of the vehicle 1 complies with the second preset driving operation and the traffic rules, no action is taken. If the sensor 40 or the camera 50 senses that the vehicle 1 has not entered the outer lane, that means the driving of the vehicle 1 does not comply with the second preset driving operation, the determining module 104 determines that the trigger condition is triggered, the process goes to block S27.

In a third embodiment, the preset driving scenario can be a driving state of the vehicle 1. The determining module 104 can obtain the driver-related parameters and the passenger-related parameters obtained by the camera 50, and determines whether the driving of the vehicle 1 complies with the preset driving operation, and the driving of the vehicle 1 complies with the traffic rules, no action is taken. If the driving of the vehicle 1 dose not comply with the preset driving operation, and the driving of the vehicle 1 does not comply with the traffic rules, for example, fatigue driving or overloading, the trigger condition is triggered, and the process goes to block S27.

At block S27, the assisting module 105 sends a driving assistance command to the vehicle 1. The driving assistance command includes at least one of emergency stop, deceleration, turning signal prompting, voice reminder, warning sound, on-vehicle light signal or on-screen display reminder. For example, in the first embodiment of the present disclosure, the assisting module 105 issues a deceleration instruction and a voice reminder to the vehicle 1 to avoid violating traffic rules, or promptly adjust driving operations when violations of traffic rules occur.

Therefore, the method for providing driving assistance and vehicle 1 extract keywords in the electronic texts of the traffic rules, generate the trigger condition based on the extracted keywords, and send the driving assisted command when the current driving parameters of the vehicle 1 satisfy the trigger condition thereby reducing illegal driving and improving driving safety.

The embodiments shown and described above are only examples. Many details are often found in the art such as the other features. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle comprising:
a processor; and
a storage device, the storage device configured to store one or more programs which, when executed by the processor, cause the processor to:
establish a database, wherein the database comprises a plurality of pre-stored keywords, the pre-stored keywords are defined as words related to traffic;
obtain electronic texts of traffic rules;
extract keywords in the electronic texts according to the database;
generate a trigger condition based on the extracted keywords;
obtain a plurality of current driving parameters of the vehicle; and
send a driving assistance command when the plurality of current driving parameters satisfies the trigger condition.

2. The vehicle of claim 1, wherein “extract the keywords in the electronic text according to the database” comprises:
comparing the electronic texts with the pre-stored keywords; and
storing words of the electronic texts which are consistent with the pre-stored keywords.

3. The vehicle of claim 1, wherein the pre-stored keywords comprise traffic-related noun words, driving-related verb words, or a combination of the traffic-related noun words and the driving-related verb words.

4. The vehicle of claim 1, wherein “obtain the electronic texts of the traffic rules” comprises:
obtain position information of the vehicle; and
obtain the electronic texts of the traffic rules by automatically downloading from the Internet or automatically switching to the traffic rules in different languages according to the position information of the vehicle.

5. The vehicle of claim 1, wherein the trigger condition comprises a preset driving scenario and a preset driving operation, the preset driving scenario is established according to the extracted keywords, and the preset driving operation complies with the traffic rules, when the vehicle is driving in the preset driving scenario and the driving of the vehicle does not comply with the preset driving operation, the trigger condition is triggered.

6. The vehicle of claim 1, wherein the plurality of current driving parameters comprises at least one of a vehicle-related parameter, a traffic-related parameter, a driver-related parameter, a passenger-related parameter, and a traffic-related parameter.

7. The vehicle of claim 6, wherein the vehicle-related parameter comprises at least one or more of a speed, an acceleration, a relative position, a yaw angle, an indicator status, a driving direction, a driving distance, an accelerator pedal signal, a braking signal, and a steering signal.

8. The vehicle of claim 6, wherein the traffic-related parameter comprises at least one of a road-related parameter, a pedestrian-related parameter, a signal light-related parameter, a traffic sign-related parameter, an environment-related parameter, and a distance between the vehicle and another front, back, left, or right vehicle.

9. The vehicle of claim 1, wherein the electronic texts of the traffic rules are obtained through OCR technology or downloading from the Internet.

10. A driving assistance method for operating a vehicle, comprising:
establishing a database, wherein the database comprises a plurality of prestored keywords, the pre-stored keywords are defined as words related to traffic;
obtaining electronic texts of traffic rules;
extracting keywords in the electronic texts according to the database;
generating a trigger condition based on the extracted keywords;
obtaining a plurality of current driving parameters of the vehicle; and
sending a driving assistance command when the plurality of current driving parameters satisfies the trigger condition.

11. The driving assistance method of claim 10, wherein the step of extracting keywords in the electronic texts according to the database comprises:
comparing the electronic texts with the pre-stored keywords; and
storing words of the electronic texts which are consistent with the pre-stored keywords.

12. The driving assistance method of claim 10, wherein the pre-stored keywords comprise traffic-related noun words, driving-related verb words, or a combination of the traffic-related noun words and the driving-related verb words.

13. The driving assistance method of claim 10, wherein the step of obtaining electronic texts of the traffic rules comprises:
obtaining position information of the vehicle; and
obtaining the electronic texts of the traffic rules by automatically downloading from the Internet or automatically switching to the traffic rules in different languages according to the position information of the vehicle.

14. The driving assistance method of claim 10, wherein the trigger condition comprises a preset driving scenario and a preset driving operation, the preset driving scenario is established according to the extracted keywords, and the preset driving operation complies with the traffic rules, when the vehicle is driving in the preset driving scenario and the driving of the vehicle does not comply with the preset driving operation, the trigger condition is triggered.

15. The driving assistance method of claim 10, wherein the plurality of current driving parameters comprise at least one of a vehicle-related parameter, a traffic-related parameter, a driver-related parameter, a passenger-related parameter, and a traffic-related parameter.

16. The driving assistance method of claim 15, wherein the vehicle-related parameter comprises at least one or more of a speed, an acceleration, a relative position, a yaw angle, an indicator status, a driving direction, a driving distance, an accelerator pedal signal, a braking signal, and a steering signal.

17. The driving assistance method of claim 15, wherein the traffic-related parameter comprises at least one of a road-related parameter, a pedestrian-related parameter, a signal light-related parameter, a traffic sign-related parameter, an environment-related parameter, and a distance between the vehicle and another front, back, left, or right vehicle.

18. The driving assistance method of claim 10, wherein the electronic texts of the traffic rules are obtained through OCR technology or downloading from the Internet.
